(19) United States
(12) Patent Application Publication
(10) Pub. No.: US 2006/0280170 A1
(43) Pub. Date: Dec. 14, 2006

(54) Voice multi-tap apparatus

(76) Inventor: Steven Cooper, Ocean Shore (AU)

Correspondence Address: GLENN PATENT GROUP, 3475 EDISON WAY, SUITE L, MENLO PARK, CA, 94025, US

(21) Appl. No.: 10/553,254

(22) PCT Filed: Apr. 8, 2004
(86) PCT No.: PCT/AU04/00478

§ 371 Date: Jun. 30, 2006

(30) Foreign Application Priority Data
Apr. 10, 2003 (AU) 2003901703

(51) Int. Cl. H04L 12/50

(52) U.S. Cl. 370/375

(57) ABSTRACT

A voice multi-tap apparatus for a communications system, the apparatus including an input connector (12) accommodating at least four input circuits, plurality of output connectors (13a-13d) incorporating respective output circuits coupled to respective input circuits; and at least one of said output connectors incorporating a second output circuit coupled to one of the input circuits via a switching device (14) whereby the operation of said switching device allows said at least one output connector service two circuits.

### CROSS-REFERENCE TO RELATED APPLICATIONS

This application claims the benefit of Australian provisional patent application number 2003901703 filed on 10 Apr. 2003 which is hereby incorporated by reference.

### BACKGROUND OF THE INVENTION

1. Field of the Invention

The present invention relates to an apparatus for providing additional access ports within a communications network. In particular, although not exclusively, the invention relates to providing additional voice line access ports of modular type connectors in a network utilising structured cabling.

2. Discussion of the Background Art

At present most conventional structured cabling systems for communications purposes within many industrial, commercial and residential premises utilise a central distribution point from which voice and data services are routed to various access points throughout the premises. Typically, a limited number of access ports are provided during construction or rewiring for any one discrete location within the premises. However, situations arise where there is a need for additional access ports to connect additional equipment such as a second telephone, a fax machine or a modem.

Generally, the solution to the above situation is to run additional cabling which can prove costly and time consuming particularly after fit-out of premises. Furthermore, this solution is most inefficient as most structured cabling is of category 5 (CAT 5) or higher. Normally telephones, faxes and modems only require access to a single signalling channel, which is generally coupled to the contact points reserved for voice channel signalling of an access port mounted in a wall plate or the like. In general, most voice channel equipment does not fully utilise all available signalling channels within a CAT 5 cable with most of the signalling capacity being wasted each time a new cable is connected.

One example of an apparatus that attempts to utilise the additional signalling pairs within a CAT 5 cabling system is the modular splitter produced by L-com Inc of North Andover, Mass. 01845 USA. As depicted in FIG. 1, the L-com splitter 1 is capable of connecting to a single RJ45 modular socket and tapping the four pairs of the CAT 5 cable to produce four separate modular output ports 2a, 2b, 2c, 2d each utilising a different wire pair to allow standard 2-point signalling. The splitter is also produced in an 8-point signalling variant in which all four modular ports are all connected to the four input pairs of the CAT 5 cable. A further variant of the splitter also includes a shield connection to each of the additional modular port.

However, the L-com splitter only allows for standard 2-point or 8-point signalling and does not accommodate devices requiring 4-point signalling such as telephone handsets with enhanced features, like the commander series and various NEC and Fujitsu handset models or Samsung digital telephone systems, or for connecting a combination of devices utilising 2 wire and 4 wire signalling.

Another example of such an apparatus is disclosed in JP 11-027405 entitled ‘Multi-point connection adaptor for Integrated Service Digital Network’. The adaptor includes an input port, a series of output ports, a 2 pole switch and a terminator. Pins TX0 and TX1 of the input port are wired to pins RX0 and RX1 of each output port. A terminator is wired between TX0 and TX1 and RX0 and RX1 on either side of the switch. Throwing the switch effectively activates or repeals the termination of either TX0 and TX1 and RX0 and RX1 pairs on each of the output sockets. However the apparatus of JP 11-027405 is generally only suited for data transmission and is not appropriate for devices utilising a voice channel.

Published US Patent Application No. 2002/0080755 entitled ‘Switching nodes and interface modules for data networks’ and assigned to International Business Machines Corporation describes an interface for connecting data links to switching nodes. The interface includes an external port for connection to the data link, a plurality of internal ports for interconnection with respective internal ports of other interface modules, a link interface connected to the external port for processing inbound data and forwarding it across the switching node, and for forwarding outbound data, a switch circuit connected between the link interface and the internal ports for transmission of data between the link interface and the internal ports and a controller for controlling the routing of the data to the internal ports according to a routing protocol. The interface is directed towards routing data within the intra-node network of a switching node (routing data between interface modules within a node), which is governed by the protocol run by the controller. Thus the interface is not readily suitable for expanding the capacity of a structured cabling port.

### SUMMARY OF THE INVENTION

### Object of the Invention

Accordingly it would be advantageous of the present invention to provided an apparatus that connects to a modular access point of a structured cabling network that provides a plurality of additional access ports for the interconnection of equipment that utilises a voice channel to the structured cabling.

Another advantage of embodiments of the invention is to provide for the connection of devices utilising 2 wire and 4 wire signalling or a combination thereof through a single structured cabling port.

### Disclosure of the Invention

In one broad form of the invention there is provided a voice multi-tap apparatus for a communications system, said apparatus including:

an input connector accommodating at least four input circuits;

a plurality of output connectors incorporating respective output circuits coupled to respective input circuits; and

at least one of said output connectors incorporating a second output circuit coupled to one of the input circuits via a switching device whereby the operation of said switching device allows said at least one output connector to service two circuits.

In another form of the invention there is provided an apparatus for providing additional modular connection ports for equipment utilising a voice channel within a structured cabling system said apparatus including:

an input port for receiving a plurality of signalling lines from an existing modular access ports within the structured cabling network;

a first switch coupled to said input via a first pair of signalling lines from the plurality of signalling lines;

a second switch coupled to said input via a second pair of signalling lines from the plurality of signalling lines; and

a plurality of modular output ports said output ports being coupled to said switches and wherein at least two of the modular output ports are directly coupled to said input by a third and forth pair of signalling lines from the plurality of signalling lines.

Preferably, the output and the input connection ports are sockets, but are most preferably modular type sockets such as RJ11, RJ12 or RJ45 sockets. Further, the sockets may also be mounted on a PCB, which is securable in within a suitable housing.

Alternatively the input and output connectors may be provided as connection plugs which connect to the access ports and terminal equipment respectively. Preferably the plugs are RJ11, RJ12 or RJ45 connection jacks for modular sockets.

The switching mechanisms may be a slide, micro, toggle or push button switches.

Preferably, the invention is implemented as a stand alone detachable remote unit but may equally be implemented as a combination of a patch panel and a remote unit.

Alternatively, the invention may be implemented in a back to back configuration providing a secondary input connection and a secondary series of output connections providing at least 4 additional circuits.

Generally, the present invention is connected to category 5 cabling but may also be interfaced to structured cabling networks of category 5E, category 6 or higher category.

### BRIEF DETAILS OF THE DRAWINGS

In order that this invention may be more readily understood and put into practical effect, reference will now be made to the accompanying drawings illustrate preferred embodiments of the invention, and wherein:

FIG. 1 is schematic diagram of the wiring layout of an example of the background art;

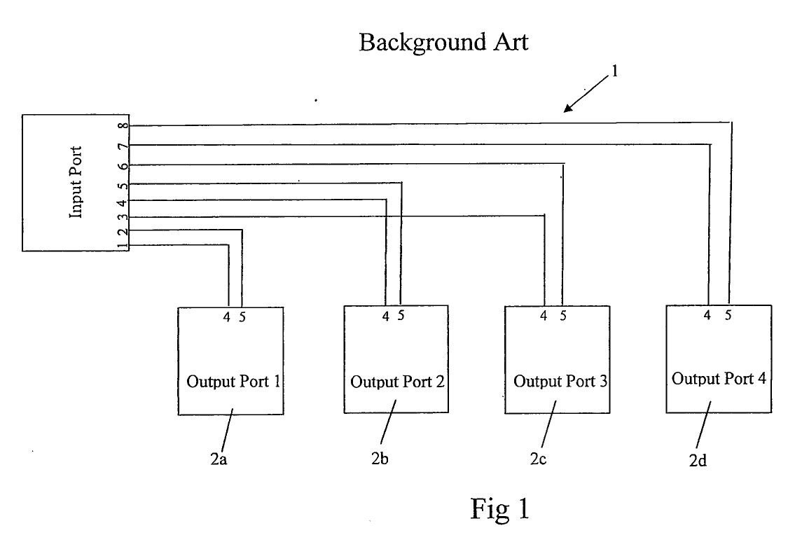

FIG. 2 is a schematic wiring diagram of one embodiment of the present invention;

FIG. 3 is a schematic wiring diagram of an alternative embodiment of the present invention; and

FIG. 4 is a schematic wiring diagram of yet another alternative embodiment of the present invention

### DESCRIPTION OF EMBODIMENTS OF THE INVENTION

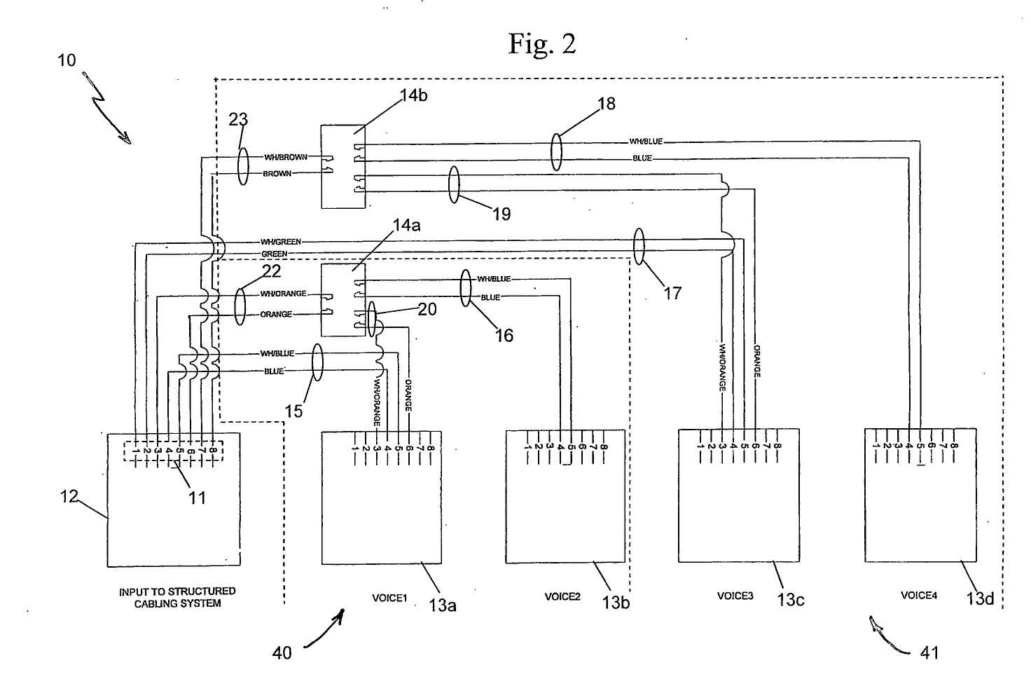

In reference to FIG. 2 there is illustrated one possible configuration of the multiple tapping apparatus (10) of the present invention. The illustrated embodiment is depicted consisting of a primary input port (12) and a plurality of output ports in this case four (13a-13d).

The input port typically utilises a connector in the form of a standard RJ45 socket having eight contact points. Most standard wiring conventions group the contacts into a series of pairs, each pair being assigned a colour coded wire. Generally the contacts are arranged in the following contact pairs; points 1&2, points 3&6, points 4&5 and points 7&8. In the present embodiment, the point pairs are assigned colour coded signalling pairs as per the unshielded twisted pair (UTP) category 5 T569A standard. This allows the tapping apparatus to be interfaced to a connection port within a structured cabling network using a standard CAT 5 pass through patch cable.

The output connectors as shown in FIG. 2 are also depicted as RJ45 type modular sockets, it is however to be understood that they may readily be replaced with RJ11 or RJ12 sockets depending on the size of the equipments connection jack. For the purposes of the description it will be convenient refer to the four outputs as voice 1 to 4.

Each voice port is coupled by wiring at least two contact points to a respective switch (14a, 14b). Each switch is inturn coupled to a specific contact pair (11) of the input port to form a first and a second circuit (40, 41) respectively.

The first circuit (40) is formed by the interconnection of switch one (14a) with voice ports 1 and 2 (13a, 13b) and the input port. The input side of switch one is coupled via a first signalling pair (22) to contact pair 3&6 of the input port, while the output side of the switch is coupled to voice ports 1 and 2 via a first and second connection wire pairs (20, 16) respectively. The first connection pair (20) being coupled to contact points 3 and 6 of voice port 1, while the second connection pair (16) is coupled to contact points 4 and 5 of voice port 2. Voice port 1 is further coupled via a third signalling pair (15) from contact points 4 and 5 to contact pair 4 & 5 of the input port.

Placing switch one in the first operative position, connects contact pair 3&6 to voice port 1, as such voice port 2 is disabled allowing voice port 1 to facilitate the interconnection of equipment requiring 4-point signalling. Placing switch one in the second operative position effectively connects contact pair 3&6 to points 4 and 5 of voice port 2 allowing both voice port 1 and 2 to connect equipment utilising standard 2-point signalling.

The second circuit (41) is formed by the interconnection of switch two (14b) with voice ports 3 and 4 (13c, 13d) and the input port. The input side of switch two is coupled via a second signalling pair (23) to contact pair 7&8 of the input port, while the output side of the switch is coupled to voice ports 3 and 4 via a third and fourth connection wire pairs (19, 18) respectively. The third connection pair (19) being coupled to contact points 3 and 6 of voice port 3 while the fourth connection pair (18) is coupled to contact points 4 and 5 of voice port 4. Voice port 3 is further coupled via a fourth signalling pair (17) from contact points 4 and 5 to contact pair 1&2 of the input port.

Switching switch two into a first operative position connects contact pair 7&8 to voice port 3, disabling voice port 4, allowing voice port 3 to facilitate the interconnection of equipment requiring 4-point signalling. Placing switch two in the second operative position effectively connects contact pair 7&8 to points 4 and 5 of voice port 4 allowing both voice port 3 and 4 to connect equipment utilising standard 2-point signalling.

Varying the combination of switch positions allows for a number of differing voice port configurations, such as two 4-point signalling ports only, one 4-point port and two standard 2-point ports or four standard 2-point ports.

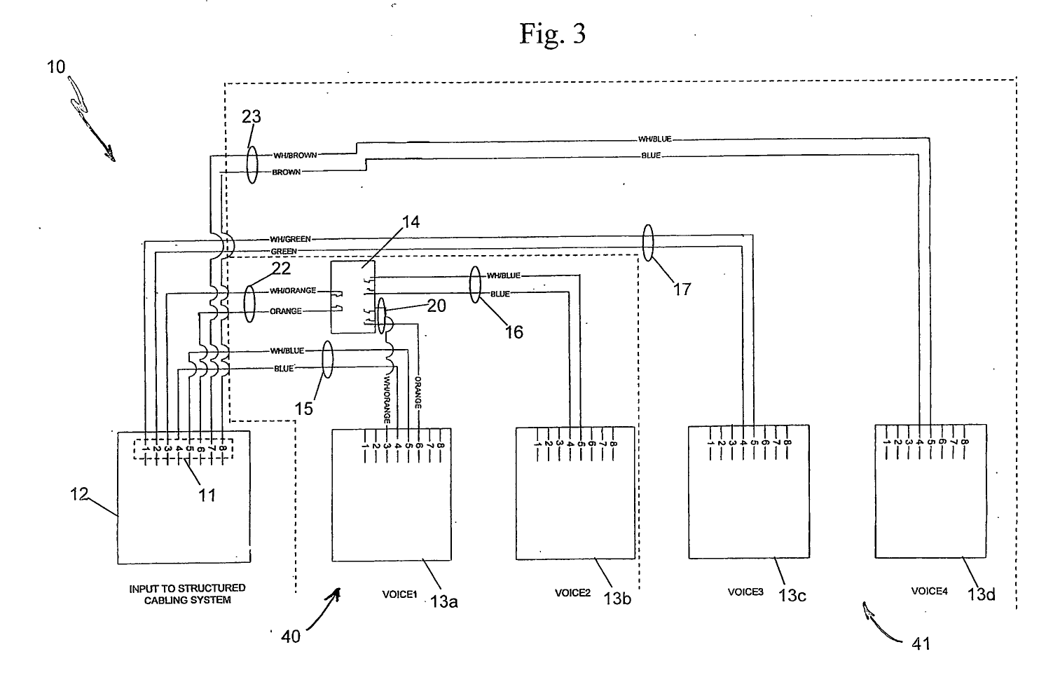

FIG. 3 depicts an alternative embodiment of the present invention, unless otherwise indicated the same reference numerals will be used to refer to the same components as in FIG. 2. The tapping apparatus according to this embodiment includes an input port (12) and a plurality of output ports (13a-13d). However, the apparatus only includes a single switch (14).

The switch is coupled in a similar manner to that of switch one discussed above, with the input side of switch is coupled via a first signalling pair (22) to contact pair 3&6 of the input port. While the output side of the switch is coupled to voice ports 1 and 2 (13a, 13b) via a first and second connection wire pairs (20, 16) respectively. The first connection pair (20) being coupled to contact points 3 and 6 of voice port 1, while the second connection pair (16) is coupled to contact points 4 and 5 of voice port 2. Voice port 1 is further coupled via a third signalling pair (15) from contact points 4 and 5 to contact pair 4 & 5 of the input port. This wiring scheme allows the tapping apparatus to be configured as either a three or a four output port apparatus.

In the four port case voice ports 3 and 4 are hardwired as standard 2-point port via signalling pair (17, 23) to contact pair 1&2 and 7&8 respectively. In this configuration switching the switch between the first and second operative positions toggles voice port 1 between a standard 2-point and 4-point port, allowing the apparatus to have one 4-point and two standard 2-point ports or all four voice ports available as standard 2-point ports.

The three port configuration omits voice port 4, having voice port 3 hardwired as a 4-point port. In this configuration switching the switch between the first and second operative positions toggles voice port 1 between a standard 2-point and 4-point port allowing the apparatus to have either two 4-point ports or one 4-point and two standard 2-point ports.

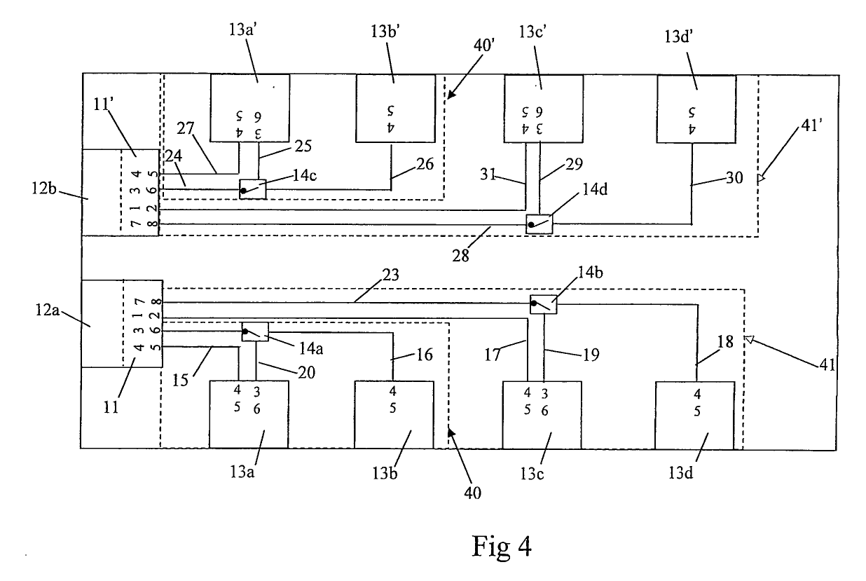

With reference to FIG. 4 there is illustrated a further alternative embodiment of the present invention, unless otherwise indicated the same reference numerals will be used to refer to the same components as in FIG. 2. The tapping apparatus according to this embodiment includes a primary input port (12a) and a secondary input port (12b). Each input port being associated with a series of modular outputs (voice ports 1 to 4 and 5 to 8).

The first series of voice ports, voice ports 1 to 4 (13a-13d) are coupled via at least two contact points to a first and second switch (14a, 14b), each switch is inturn coupled to a specific contact pair (11) of the primary input port to form a first and a second circuit (40, 41) respectively. The second series of voice ports, voice ports 5 to 8 (13a′-13d′) are coupled via at least two contact points to a third and fourth switch (14c, 14d) each switch is inturn coupled to a specific contact pair (11′) of the secondary input port to form a third and a fourth circuit (40′, 41′) respectively.

The first circuit (40) is formed by the interconnection of switch one (14a) with voice ports 1 and 2 (13a, 13b) and the input port. The input side of switch one is coupled via a first signalling pair (22) to contact pair 3&6 of the input port, while the output side of the switch is coupled to voice ports 1 and 2 via a first and second connection wire pairs (20, 16) respectively. The first connection pair (20) being coupled to contact points 3 and 6 of voice port 1, while the second connection pair (16) is coupled to contact points 4 and 5 of voice port 2. Voice port 1 is further coupled via a fifth signalling pair (15) from contact points 4 and 5 to contact pair 4 & 5 of the input port.

The second circuit (41) is formed by the interconnection of switch two (14b) with voice ports 3 and 4 (13c, 13d) and the input port. The input side of switch two is coupled via a second signalling pair (23) to contact pair 7&8 of the input port, while the output side of the switch is coupled to voice ports 3 and 4 via a third and fourth connection wire pairs (19, 18) respectively. The third connection pair (19) being coupled to contact points 3 and 6 of voice port 3 while the fourth connection pair (18) is coupled to contact points 4 and 5 of voice port 4. Voice port 3 is further coupled via a sixth signalling pair (17) from contact points 4 and 5 to contact pair 1&2 of the input port.

The third circuit (40′) is formed by the interconnection of switch three (14c) with voice ports 5 and 6 (13a′, 13b′) and the input port. The input side of switch three is coupled via a third signalling pair (24) to contact pair 3&6 of the secondary input port, while the output side of the switch is coupled to voice ports 5 and 6 via a fifth and sixth connection wire pairs (25, 26) respectively. The fifth connection pair (25) being coupled to contact points 3 and 6 of voice port 5, while the sixth connection pair (26) is coupled to contact points 4 and 5 of voice port 6. Voice port 5 is further coupled via a seventh signalling pair (27) from contact points 4 and 5 to contact pair 4 & 5 of the secondary input port.

The fourth circuit (41′) is formed by the interconnection of switch four (14d) with voice ports 7 and 8 (13c′, 13d′) and the input port. The input side of switch four is coupled via a fourth signalling pair (28) to contact pair 7&8 of the secondary input port, while the output side of the switch is coupled to voice ports 7 and 8 via a seventh and eighth connection wire pairs (29, 30) respectively. The seventh connection pair (29) being coupled to contact points 3 and 6 of voice port 7 while the eighth connection pair (30) is coupled to contact points 4 and 5 of voice port 8. Voice port 7 is further coupled via a eighth signalling pair (31) from contact points 4 and 5 to contact pair 1&2 of the secondary input port.

Placing switch one in the first operative position, connects contact pair 3&6 of the primary input port to voice port 1, as such vice port 2 is disabled allowing voice port 1 to facilitate the interconnection of equipment requiring 4 wire signalling. Placing switch 1 in the second operative position effectively connects contact pair 3&6 to points 4 and 5 of voice port 2 allowing both voice ports 1 and 2 to connect equipment utilising standard 2-point signalling.

A similar operation occurs on the secondary side of the apparatus, when switch three is toggled between a first and second operative position. In the first operative position, contact pair 3&6 of the secondary input port are coupled to voice port 5, disabling voice port 6 allowing voice port 5 to be utilised as a 4-point port. In the second operative position, contact pair 3&6 of the secondary input port are coupled to points 4 and 5 of voice port 6 allowing voice ports 5 and 6 to be utilised as 2-point ports.

Switching switch two into a first operative position connecting contact pair 7&8 to voice port 3, disabling voice port 4, allowing voice port 3 to facilitate the interconnection of equipment requiring 4 point signalling. Placing switch 2 in the second operative position effectively connects contact pair 7&8 to points 4 and 5 of voice port 4 allowing both voice port 3 and 4 to connect equipment utilising standard 2-point signalling.

Similarly, on the secondary side toggling switch four between a first and second operative position. In the first operative position, contact pair 7&8 of the secondary input port are coupled to voice port 7, disabling voice port 8. This allows voice port 7 to be utilised as a 4-point port. In the second operative position, contact pair 3&6 of the secondary input port are coupled to points 4 and 5 of voice port 8 allowing voice ports 7 and 8 to be utilised as 2-point ports.

In this form, the tapping apparatus may be interfaced using two standard pass through cables to a first and a second existing access points available at a specific locations (such as a specific work area) within the structured cabling network. Varying the switch positions allows users to connect various 4-point and 2-point signalling devices which is advantageous in building where space is limited.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. A voice multi-tap apparatus for a communications system, said apparatus including:
an input connector accommodating at least four input circuits for voice communication;
a plurality of output connectors incorporating respective output circuits coupled to respective input circuits; and
at least one of said output connectors incorporating a second output circuit coupled to one of the input circuits via a switching device whereby the operation of said switching device allows said at least one output connector to service two circuits for voice communication.

2. The apparatus of claim 1 wherein the input connector is a connection socket.

3. The apparatus of claim 1 wherein at least one of the output connectors is a connection socket.

4. The apparatus of either claim 2 or claim 3 wherein the connection socket is a modular type socket, preferably selected from the group including RJ11, RJ12 and RJ45 type sockets.

5. The apparatus of claim 1 wherein the input connector is a connection plug.

6. The apparatus of claim 1 wherein at least one of the output connectors is a connection plug.

7. The apparatus of either claim 5 or claim 6 wherein the connection plug is a modular type jack, preferably selected from the group including RJ11, RJ12 and RJ45 type jacks.

8. The apparatus of any one of the preceding claims wherein the input and/or output connectors are mounted on a printed circuit board.

7. The apparatus of any one of the preceding claims wherein the switching mechanism is a slide switch, a micro switch, a toggle switch or a push button switch.

8. An apparatus for providing additional modular connection ports for equipment utilising a voice channel within a structured cabling system, said apparatus including:
an input port for receiving a plurality of signalling lines from existing modular access ports within the structured cabling network;
a first switch coupled to said input via a first pair of signalling lines from the plurality of signalling lines;
a second switch coupled to said input via a second pair of signalling lines from the plurality of signalling lines; and
a plurality of modular output ports, said output ports being coupled to said switches and wherein at least two of the modular output ports are directly coupled to said input by a third pair and a fourth pair of signalling lines from the plurality of signalling lines.

9. An apparatus for providing additional modular connection ports for equipment utilising a voice channel within a structured cabling system said apparatus including:
a first input port for receiving a plurality of signalling lines from existing modular access ports within the structured cabling network;
a first switch coupled to said first input via a first pair of signalling lines from the plurality of signalling lines;
a second switch coupled to said input via a second pair of signalling lines from the plurality of signalling lines; and
a first set of modular output ports, said output ports being coupled to said first and second switches and wherein at least two ports of the first set of output ports are directly coupled to said first input by a third pair and a forth pair of signalling lines from the plurality of signalling lines.
a second input port for receiving a plurality of signalling lines from existing modular access ports within the structured cabling network;
a third switch coupled to said second input via a fifth pair of signalling lines from the plurality of signalling lines;
a fourth switch coupled to said second input via a sixth pair of signalling lines from the plurality of signalling lines; and
a second set of modular output ports, said output ports being coupled to said third and fourth switches and wherein at least two ports from the second set of output ports are directly coupled to said second input by a seventh pair and an eighth pair of signalling lines from the plurality of signalling lines.

10. The apparatus of either claim 8 or claim 9 wherein the input port includes a connection socket.

11. The apparatus of either claim 8 or claim 9 wherein at least one of the output ports includes a connection socket.

12. The apparatus of either claim 10 or claim 11 wherein the connection sockets are modular type sockets, preferably selected from the group including RJ11, RJ12 and RJ45 type sockets.

13. The apparatus of claim 8 or claim 9 wherein at least on of the input ports and at least one of the output ports is a connection plug.

14. The apparatus of claim 13 wherein the connection plug is a modular type jack, preferably selected from the group including RJ11, RJ12 and RJ45 type jacks.

15. The apparatus of any one of claims 8 to 14 wherein the input and/or output ports are mounted on a printed circuit board.

16. The apparatus of any one of claims 8 to 15 wherein the switching mechanism is a slide switch, a micro switch, a toggle switch or a push button switch.

17. The apparatus of claim 9 wherein the second input port and said second set of modular output ports are arranged in a back to back configuration with the first input and said first set of output ports.
